(19) United States
(12) Patent Application Publication
(10) Pub. No.: US 2024/0115366 A1
(43) Pub. Date: Apr. 11, 2024

(54) ORAL APPLIANCE FOR DENTAL HYGIENE

(71) Applicants: Audrey Lawrence Rosenberg, Westport, CT (US); Jack Louis Rosenberg, Westport, CT (US)

(72) Inventors: Audrey Lawrence Rosenberg, Westport, CT (US); Jack Louis Rosenberg, Westport, CT (US)

(21) Appl. No.: 17/962,372

(22) Filed: Oct. 7, 2022

(51) Int. Cl. A61C 17/02; A46B 5/02; A46B 9/04; A46B 15/00; A46D 1/00; A61C 17/34

(52) U.S. Cl. CPC A61C 17/0211; A46B 5/02; A46B 9/045; A46B 15/0087; A46D 1/0284; A61C 17/3481

(57) ABSTRACT

A whole-mouth dental hygiene apparatus includes first and second channel configured to fit over a user's entire teeth sets of the upper and lower jaw. The channels are aligned along a dividing wall and include rod-like projections extending from their surrounding walls into interiors of each channel, configured for scrubbing enamel and massaging gums through chewing action. The rod-like projections are formed of a molded silicon rubber material together with an entirety of the apparatus. The apparatus includes a handle for manipulating the apparatus attached to its exterior, positioned to protrude from a user's mouth when the apparatus is in use. The apparatus includes openings in the walls of each channel to allow for passage of fluid during use.

### FIELD

The present application relates to oral appliances for dental hygiene, and to ornamental designs for such oral appliances.

### BACKGROUND

Disabled, special needs and elderly patients often struggle to maintain a healthy dentition, and consequently are at high risk of gingivitis, constant infection and risk of heart disease related to dental caries, which also leads to root canal, infections, pain, and extractions. In recent studies, pneumonia, candidiasis, and now Alzheimer's diseases have also been associated with gingival inflammation from poor oral and dental hygiene. Caseworkers and nursing assistants are seldom instructed in dental care, so patients who cannot get to a bathroom very rarely receive daily dental care. Without brushing the teeth and removal of bacterial plaque that irritates the gingiva (gums), the patient's gums become inflamed and bleed easily. When the gums bleed, bacteria can enter directly into the bloodstream, raising the risk of sepsis.

Thus, dental care of developmentally challenged patients too often consists of general anesthesia and extractions. By the time these patients are in their twenties, there are often few remaining teeth. Because finances are tight for most of these families, and fitting dentures is next to impossible, these patients go without teeth, reducing their diets to baby food and similar pureed or very soft foods. An appliance to make regular oral and dental hygiene practical for disabled, special needs and elderly patients is sorely needed to reduce dire outcomes of long-term oral hygiene neglect. Such an appliance may also be useful for regular users also, when cleaning with a brush is not a convenient option.

One solution is a full mouth toothbrush as disclosed in U.S. Pat. No. 9,486,061 (Rosenberg) that one just needs to chew on to obtain gingival massage and plaque removal. Rosenberg's full mouth toothbrush is a simple solution for anyone who cannot use a bathroom or electric toothbrush: hospitalized or bedridden patients, stroke victims, elderly, autistic, or down syndrome patients, deployed solders, or anyone who wants to get a quick brush away from home. The user simply places the appliance in the mouth, chews on the appliance for about a minute, and is finished. While other full mouth brushes are available, other designs do not allow proper cleaning and drying. Without proper cleaning and drying of the appliance, bacteria and food debris will be trapped, and bacteria will be reintroduced into the mouth, continuing infection and disease. Food debris trapped in the appliance will become rancid. Without proper air flow to allow for the appliance to dry, mold will grow within hours of use.

Rosenberg's full mouth toothbrush contains channels that allow fluids to travel around the mouth and throughout the appliance, enable an adequate air flow through and around the appliance for drying, while also providing gingival massage and plaque removal. Channels connecting through the structure sides and biting surfaces are included to promote proper hygiene. These channels prevent microbial and fungal growth in the device. Holes, spaces, slots, that connect the inside and outside of the appliance walls create channels, allowing fluid to drain and help users deal more comfortably with saliva, toothpaste or mouthwash, which might otherwise cause gagging.

Despite the advantages of Rosenberg's full mouth toothbrush, new manufacturing technologies have made feasible production of improved full mouth appliances. It would be desirable, therefore, to use new manufacturing technologies and designs for full mouth oral hygiene appliances that improve on past designs, providing superior functionality, durability, convenience, and comfort at an affordable cost.

### SUMMARY

This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

In an aspect of the disclosure, a whole-mouth dental hygiene apparatus may include a first arcuate open channel configured to receive upper jaw teeth. The first channel may be lined with a plurality of rod-like projections extending from its surrounding wall into an interior of the first channel for contacting upper jaw teeth, made of silicone rubber molded integrally with walls of the open channel. The rod-like projections may be within a range of about 0.7 to 3 mm in diameter, or other suitable diameter, and perform a scrubbing and massaging function like soft bristles of a conventional brush.

The whole-mouth dental hygiene apparatus may include a second arcuate open channel configured to receive lower jaw teeth, configured similarly to the first channel. The second channel may be coupled to the first channel along a dividing wall separating the first channel from second channel, and similarly to the first channel may be lined with a rod-like projections extending from its surrounding wall into its interior for contacting lower jaw teeth. At least the first and second channels and the rod-like projections of both channels may be formed together of a molded, food-grade silicon rubber material, for example, by injection molding as a single piece. The food-grade silicone rubber is safe to use, hygienic, rinses easily and dries quickly, discouraging bacterial and fungal growth. Suitable alternatives to silicone rubber may include other polymers safe for oral use, such as, for example, latex rubber, thermoplastic elastomers, or thermoplastic polyurethane.

The whole-mouth dental hygiene apparatus may further include a handle for manipulating the apparatus attached to an exterior of the first and second channels, positioned to protrude from a user's mouth when the apparatus is in use. A wide handle makes the apparatus easier for disabled patients or their caregivers to handle and place in the mouth. Besides using the jaw motion or “chewing” to brush, if the user can move the handle back and forth while chewing, providing a sonic chewing action. In an aspect, the handle may be formed together of the molded silicon rubber material with the first and second channels and their rod-like projections.

The whole-mouth dental hygiene apparatus may further include a plurality of openings through exterior walls of the first and second open channels providing fluid communication between interiors of the channels, where the teeth are scrubbed by the rod-like projections, through the exterior walls to an exterior of the apparatus. The apparatus may include a second plurality of openings through the dividing wall providing fluid communication between the first and second open channels, so that mouthwash, saliva, and water can be exchanged between the interior channels. In an aspect, the second plurality of openings may be joined at the dividing wall between the first and second channels. Optionally, the second plurality of openings may be joined to the first plurality of openings.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the examples may be employed. Other advantages and novel features will become apparent from the following detailed description when considered in conjunction with the drawings and the disclosed examples, which encompass all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify like elements correspondingly throughout the specification and drawings.

FIG. 1 is a perspective view of an integrally molded whole-mouth dental hygiene appliance.

FIG. 2 is a plan view of the whole-mouth dental hygiene appliance shown in FIG. 1.

FIG. 3 is a side view of the whole-mouth dental hygiene appliance shown in FIG. 1.

FIG. 4 is a front view of the whole-mouth dental hygiene appliance shown in FIG. 1.

FIG. 5 is a rear view of the whole-mouth dental hygiene appliance shown in FIG. 1.

FIG. 6 is a perspective view of a whole-mouth dental hygiene appliance including features for vibrating the appliance during use.

FIG. 7 is an alternative view of the appliance shown in FIG. 6, additionally showing a power/data cable for connecting to a smart phone or the like.

### DETAILED DESCRIPTION

Various aspects are now described with reference to the drawings. In the following description, for purposes of explanation, numerous specific details are set forth to provide a thorough understanding of one or more aspects. It may be evident, however, that the various aspects may be practiced without these specific details.

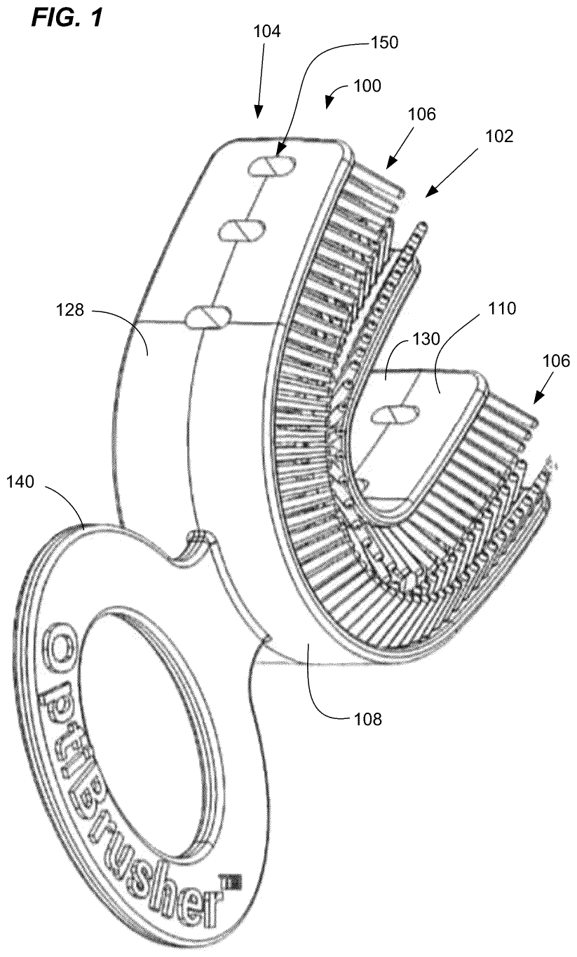

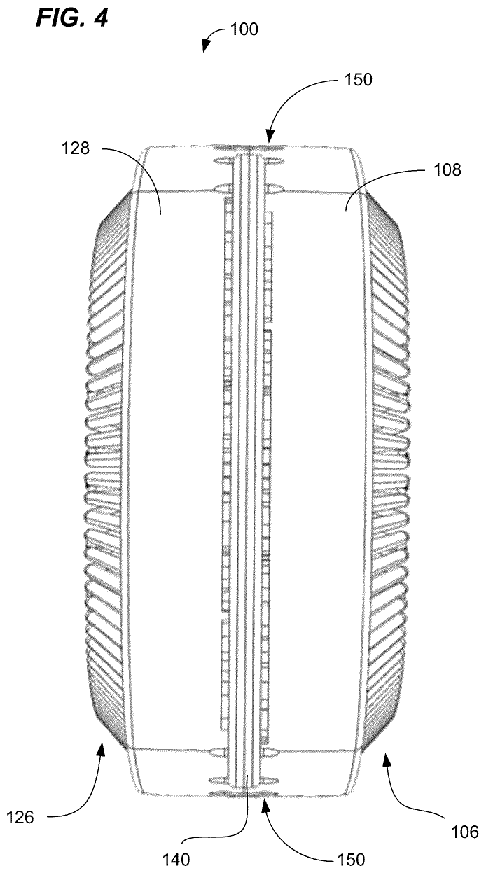

Referring to FIGS. 1-5, a whole-mouth dental hygiene apparatus 100 may include a first arcuate open channel 102 configured to receive upper jaw teeth. The first channel 102 may be lined with rod-like projections 106, 126 extending from its surrounding wall 108, 110, 112 into an interior of the first channel for contacting upper jaw teeth, made of silicone rubber molded integrally with walls 108, 110, 112 of the open channel.

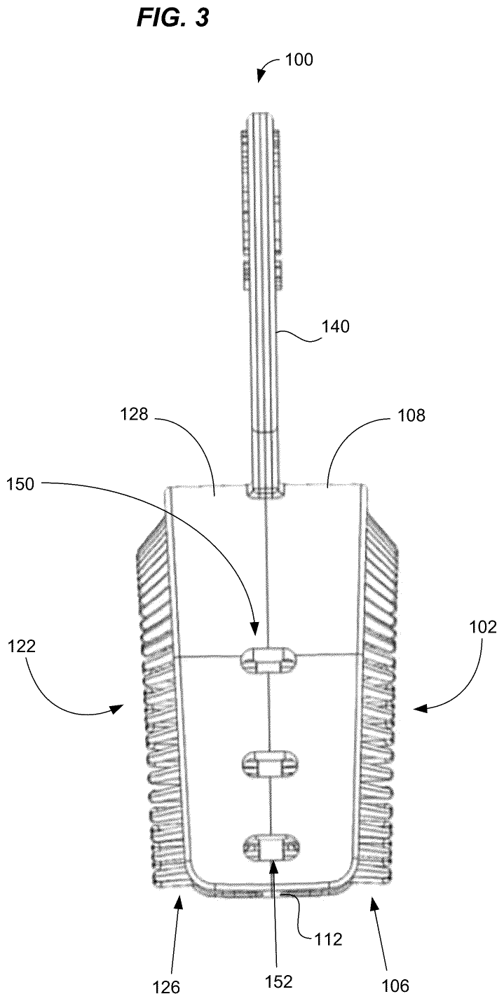

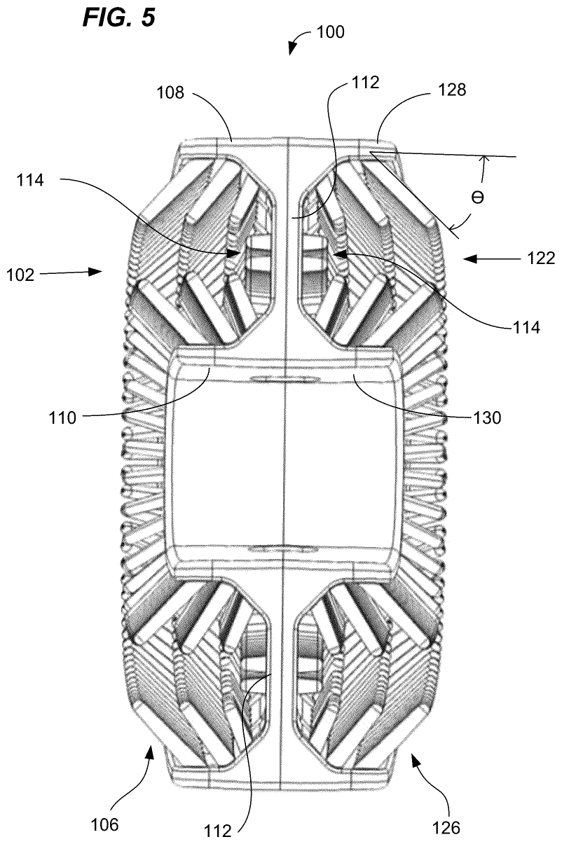

The whole-mouth dental hygiene apparatus 100 may include a second arcuate open channel 122 configured to receive lower jaw teeth, configured similarly to the first channel 102. The second channel 102 may be coupled to the first channel along and by the dividing wall 112 separating the first channel 102 from second channel 122. Similarly to the first channel 102, the second channel 122 is lined with rod-like projections 126 extending from its surrounding walls 128, 130, 112 into its interior for contacting lower jaw teeth. The dividing wall 112 (visible in FIGS. 3, 5) between the channels 102, 122 is common to both.

At least the first and second channels 102, 122 and the rod-like projections 106, 126 of both channels may be formed together of a molded, food-grade silicon rubber material. The food-grade silicone rubber is safe to use, hygienic, rinses easily and dries quickly, discouraging bacterial and fungal growth. The rod-like projections 102, 126 may be within a range of about 0.7 to 3 mm in diameter or other suitable diameter, for performing a scrubbing and massaging function like soft bristles of a conventional brush.

The whole-mouth dental hygiene apparatus 100 may further include a handle 140 for manipulating the apparatus 100, attached to an exterior wall 108, 128 of the first and second channels 102, 122, positioned to protrude from a user's mouth when the apparatus is in use. A wide handle 140 makes the apparatus 100 easier for disabled patients or their caregivers to handle and place in the mouth. Besides using the jaw motion or “chewing” to brush, if the user can move the handle back and forth while chewing, a cleansing effect greater than chewing alone may be realized. In an aspect, the handle 140 may be formed together of the molded silicon rubber material with the first and second channels 102, 122 and their rod-like projections 106, 126. The handle 140 may be configured as an oval having an open interior configured to receive fingers of a user's hand. Optionally, the handle 140 may be configured to couple mechanically with a vibrational motor unit for vibrating the whole-mouth dental hygiene apparatus during use.

The whole-mouth dental hygiene apparatus 100 may further include a plurality of openings 150 through exterior walls 108, 128 of the first and second open channels 102, 122 providing fluid communication between interiors of the channels 102, 122, where the teeth are scrubbed by the rod-like projections 102, 126, through the exterior walls 108, 128 to an exterior of the apparatus. The apparatus 100 may include a second plurality of openings 152 (FIG. 3, visible through the openings 150) through the dividing wall 112 providing fluid communication between the first and second open channels 102, 122, so that mouthwash, saliva, and water can be exchanged between the interior of the channels. In an aspect, the second plurality of openings 152 may be joined at the dividing wall 112 between the first and second channels. to the first plurality of openings 150, as illustrated.

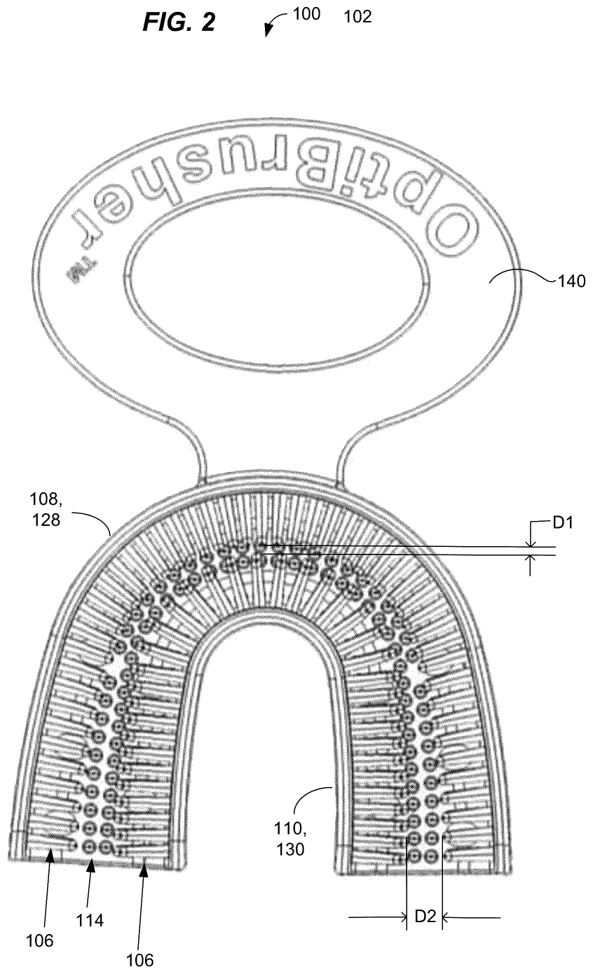

The rod-like projections 106, 126 may be configured as bristles for scrubbing tooth enamel and massaging gums. The tips of each of the rod-like projections may be rounded for engaging a user's teeth. Facing tips of the first and second pluralities of rod-like projections 106, 126 on opposing walls of the first and second channels (e.g., first exterior wall 108 opposing first interior wall 110 and second exterior wall 128 opposing second interior wall 130) may be spaced a distance apart to provide a space for receiving a user's teeth while engaging exterior surfaces thereof. Referring to FIG. 2, the distance that the facing tips are spaced apart may be in a range of 2 mm (D1) to 12 mm (D2).

The distance (D1 to D2) between facing tips of bristles may vary to accommodate teeth of varying width, from incisors to molars. For example, the distance that the facing tips are spaced apart varies from a lower end of the range (D1) at a portion of the first and second open channels proximal to the handle 140 to a higher end of the range (D2) at portions of the first and second open channels distal from handle 140.

The first and second pluralities of rod-like projections 106, 126 on opposing walls of the first and second channels 102, 122 may be arranged in at least three rows, for example, from three to about ten rows, depending on the diameter of the rod-like projections. Space should be left between adjacent projections to allow for flexure of the bristles and passage of fluid, for example, 2 to 5 mm.

In another aspect, ones of the first and second pluralities of rod-like projections may be oriented at an angle ‘Θ’ relative to an arcuate exterior wall 108, 128 of the apparatus in a range of 30 to 90 degrees. For example, ones of the first and second pluralities of rod-like projections may be oriented at a characteristic angle in each respective one of the at least three rows. In an aspect, the characteristic angle may vary from a greater end of the range (e.g., 75°) at a proximal one of the at least three rows proximal to the dividing wall 112 to a lower end of the range (e.g., 45°) at a distal one of the at least three rows distal from the dividing wall, as illustrated in FIG. 5. As shown in FIG. 2, each of the rod-like projections 106, 126 is generally perpendicular to the wall to which it is attached, in a plane parallel to the handle 140 and upper or lower edges of the apparatus 100 (i.e., in plan view).

In another aspect, each of the rod-like projections 106, 126 may be tapered from a broader base to a narrower tip. Ones of the rod-like projections 114 extending from the dividing wall 112 may be substantially shorter than ones of the rod-like projections extending from other walls of the first and second open channels, as shown in FIG. 5.

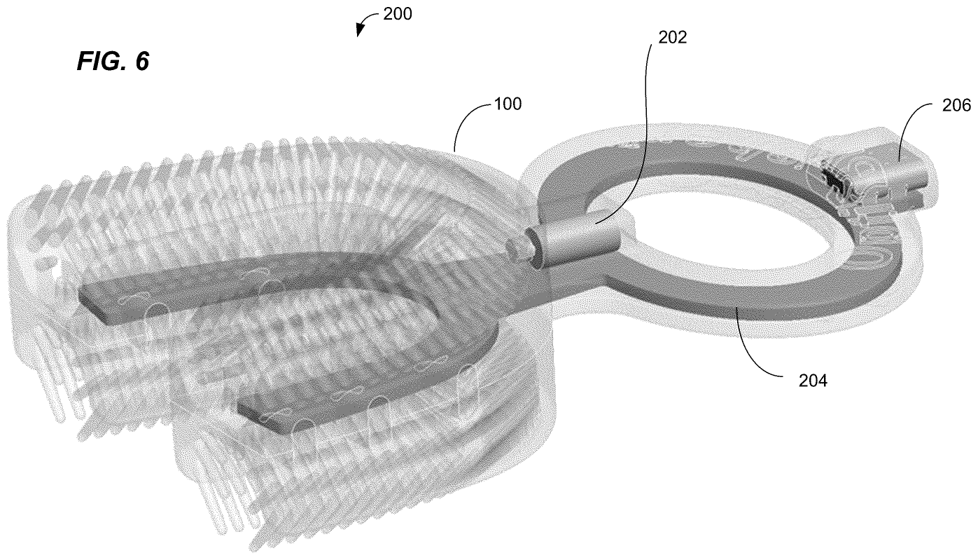

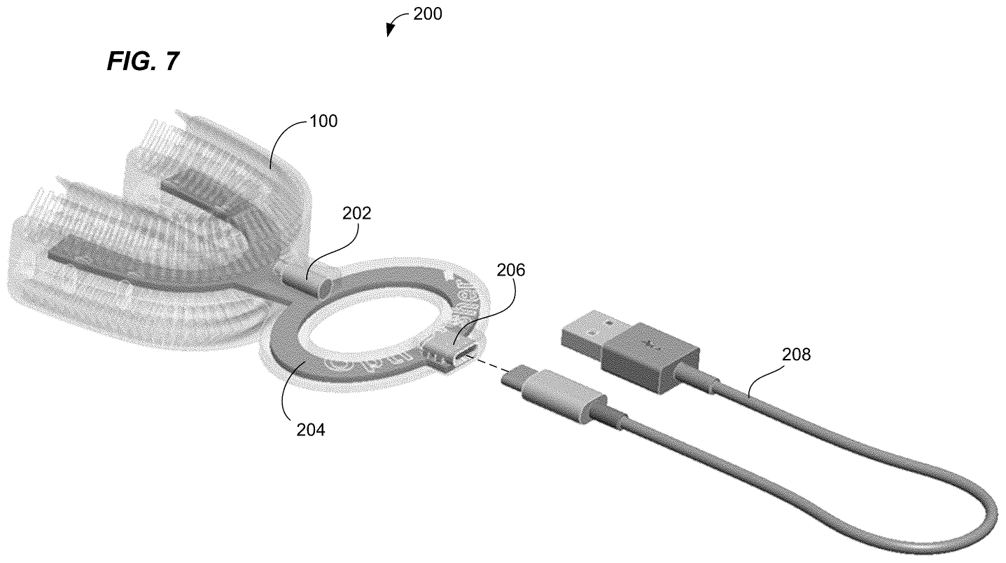

In an aspect, as shown in FIGS. 6 and 7, a vibration motor 202 may be mechanically coupled to the apparatus to increase relative motion between user's teeth and the apparatus 200, including the rod-like projections 106, 126 of the mouthpiece 100, which may be identical or similar to the appliance 100 described above. The vibration-enhanced appliance 200 may further include features for adding vibration, including the vibration motor 202 and related features. The vibration motor 202 may be mechanically coupled to the apparatus 200 at least in part by a stiffener 204 molded into at least one of the dividing wall or exterior walls of the first and second channels. The stiffener 204 may be, or may include, a printed circuit board coupled to the motor 202 and to a coupling 206 for attaching a power supply and/or control unit. In an alternative, or in addition, the stiffener may include a polymer material with a substantially higher modulus of elasticity than the material used to form the mouthpiece 100. The vibration motor 202 may be, or may include, a brushless, coreless, or iron core motor configured with an eccentric rotating mass, or other suitable motor.

In an aspect, a smart phone (not shown) may be connected to the vibration motor 202 via a cable 208, for example an USB cord. Advantageously, the smart phone may supply power from its battery to the motor 202 via the cable 208. The smart phone may execute a mobile application for controlling the motor, logging use of the mouthpiece, and providing the user with instructions and tips for using the vibrating mouthpiece 200. In an alternative, or in addition, a wireless coupling to the smartphone may be used to control the motor 202, and a rechargeable battery (not shown) may be positioned in or near the handle for powering the motor 202.

The previous description of the disclosed aspects is provided to enable any person skilled in the art to make or use the present disclosure. Various modifications to these aspects will be clear to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A whole-mouth dental hygiene apparatus, comprising:
a first arcuate open channel configured to receive upper jaw teeth, the first channel lined with a first plurality of rod-like projections extending from its surrounding wall into an interior of the first channel for contacting upper jaw teeth;
a second arcuate open channel configured to receive lower jaw teeth coupled to the first channel along a dividing wall separating the first channel from second channel, the second channel lined with a second plurality of rod-like projections extending from its surrounding wall into an interior of the second channel for contacting lower jaw teeth, wherein at least the first and second channels and the first and second pluralities of rod-like projections are formed together of a molded silicon rubber material; and
a handle for manipulating the apparatus attached to an exterior of the first and second arcuate channels positioned to protrude from a user's mouth when the apparatus is in use.

2. The apparatus of claim 1, wherein the handle is formed together of the molded silicon rubber material with the first and second channels and the first and second pluralities of rod-like projections.

3. The apparatus of claim 1, further comprising a first plurality of openings through exterior walls of the first and second open channels providing fluid communication between interiors thereof through the exterior walls to an exterior of the apparatus.

4. The apparatus of claim 3, further comprising a second plurality of openings through the dividing wall providing fluid communication between the first and second open channels.

5. The apparatus of claim 3, wherein the second plurality of openings are joined at the dividing wall between the first and second channels.

6. The apparatus of claim 5, wherein the second plurality of openings is joined to the first plurality of openings.

7. The apparatus of claim 1, wherein the handle is configured as an oval having an open interior configured to receive fingers of a user's hand.

8. The apparatus of claim 1, wherein tips of each of the rod-like projections are rounded for engaging a user's teeth.

9. The apparatus of claim 1, wherein facing tips of the first and second pluralities of rod-like projections on opposing walls of the first and second channels are spaced a distance apart to provide a space for receiving a user's teeth while engaging exterior surfaces thereof.

10. The apparatus of claim 1, wherein the distance that the facing tips are spaced apart is in a range of 2 to 12 mm.

11. The apparatus of claim 10, wherein the distance that the facing tips are spaced apart varies from a lower end of the range at a portion of the first and second open channels proximal to the handle to a higher end of the range at portions of the first and second open channels distal from handle.

12. The apparatus of claim 1, wherein the first and second pluralities of rod-like projections on opposing walls of the first and second channels are arranged in at least three rows.

13. The apparatus of claim 12, wherein ones of the first and second pluralities of rod-like projections are oriented at an angle relative to an arcuate exterior wall of the apparatus in a range of 30 to 90 degrees.

14. The apparatus of claim 13, wherein ones of the first and second pluralities of rod-like projections are oriented at a characteristic angle in each respective one of the at least three rows.

15. The apparatus of claim 13, wherein the characteristic angle varies from a greater end of the range at a proximal one of the at least three rows proximal to the dividing wall to a lower end of the range at a distal one of the at least three rows distal from the dividing wall.

16. The apparatus of claim 1, wherein each of the rod-like projections are tapered from a broader base to a narrower tip.

17. The apparatus of claim 1, wherein ones of the rod-like projections extending from the dividing wall are substantially shorter than ones of the rod-like projections extending from other walls of the first and second open channels.

18. The apparatus of claim 1, further comprising a vibration motor mechanically coupled to the apparatus.

19. The apparatus of claim 18, wherein the vibration motor is mechanically coupled to the apparatus at least in part by a stiffener molded into at least one of the dividing wall or exterior walls of the first and second channels.

20. An ornamental design for a whole-mouth dental hygiene apparatus as shown in FIGS. 1 through 5.
